(19) United States
(12) Patent Application Publication
(10) Pub. No.: US 2011/0288988 A1
(43) Pub. Date: Nov. 24, 2011

(54) LENDING MODEL PROVIDING UNSECURED STUDENT LOANS

(76) Inventor: Hector Vizcarrondo, Miami, FL (US)

(21) Appl. No.: 12/782,773

(22) Filed: May 19, 2010

(51) Int. Cl. G06Q 40/00; G06Q 50/00

(52) U.S. Cl. 705/38; 705/327

(57) ABSTRACT

A lending model provides unsecured or secured student loans to people without credit history or a country-based cosigner. The lending model may require students to pay a certain percentage of tuition in cash before starting their coursework. Schools may lend the remaining portion of tuition at a predetermined point through the program. Unsecured loans, while they may be high-risk, may provide schools with a high percentage of net present value tuition recovery and, in some cases, full net present value recovery. These loans may also be secured by requiring borrowers to provide a collateral or cosigner that would guarantee the loan. The lending model of the present invention may also allow friends, family, external investors and alumni to invest or donate towards the prospective student's tuition expenses by using a peer-to-peer (p2p) lending platform, thereby increasing the total funds in the system and reducing the liability and exposure for the school. This loan would be packaged as a single loan towards the student's tuition costs.

### BACKGROUND OF THE INVENTION

The present invention relates to lending models and, more particularly, to lending models to provide, evaluate, generate and manage unsecured and secured student loans to people without credit history in the school's country or a country-based cosigner

Presently, prospective students without sufficient credit history face a difficult challenge trying to obtain access to student loans unless a cosigner guarantees the loan. This is especially the case for international prospective students at higher education programs who generally have few alternatives for funding their education and do not have a credit history or a cosigner. Furthermore, higher education institutions are always trying to find ways to increase the number of applicants to their programs (in order to have a larger pool of people they can accept), as well as trying to maximize the capacity of their classrooms (as they benefit from each additional student without significant incremental cost).

Therefore, there is a need to allow higher education schools to improve their revenue management policies and increase diversity by providing students and schools with alternative lending models.

### SUMMARY OF THE INVENTION

In one aspect of the present invention, a method for lending money to a student comprises obtaining a school application and a financial aid application from the student, wherein the application specifies a percentage of tuition, as an upfront payment, that the student will pay before beginning a program at the school; providing a preliminary loan offer to the student and the school; providing a final offer to the student and the school; and distributing a final loan disbursement to the school, wherein the final loan disbursement is made after a predetermined amount of coursework is completed by the student.

In another aspect of the present invention, a lending model comprises a single loan packaged for a student at a school, the single loan including optional investments from friends and family and external investors, wherein the amount of the single loan is a preset amount less an upfront payment provided by the student to the school, in which the preset amount is a percentage of total tuition fees for a pre-determined program at the school.

These and other features, aspects and advantages of the present invention will become better understood with reference to the following drawings, description and claims.

### BRIEF DESCRIPTION OF THE DRAWINGS

FIG. 1 is a flow chart describing the major stages in the lending model according to an embodiment of the present invention;

FIG. 2 is a flow chart describing the student loan application process according to one of the stages of FIG. 1;

FIG. 3 is a flow chart describing a preliminary loan offer to students and schools according to one of the stages of FIG. 1; and

FIG. 4 is a flow chart describing a friends and family investment period, according to one of the stages of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a lending model to provide unsecured or secured student loans to people without credit history or a country-based cosigner. The lending model of the present invention may require students to pay a certain percentage of tuition in cash before starting their coursework. Schools may lend the remaining portion of tuition at a predetermined point through the program. Unsecured loans, while they may be high-risk, may provide schools with a high percentage of net present value tuition recovery and, in some cases, full net present value recovery. These loans may also be secured by requiring borrowers to provide a collateral or cosigner that would guarantee the loan. The lending model of the present invention may also allow friends, family, external investors and alumni to invest or donate towards the prospective student's tuition expenses by using a peer-to-peer (p2p) lending platform, thereby increasing the total funds in the system and reducing the liability, the student's interest rate, as well as the exposure for the school. As an alternative or in addition to the p2p lending platform, email/mail correspondence may be used for users to communicate and interact.

An external entity or an in-house school operation may serve as a credit risk evaluator and a loan processor, and may facilitate schools to lend money by using the university endowment portfolio, a donor's trust, or a school trust where un-secured or secured loan notes are allocated. This entity may also set pricing for loan contracts hold by users (students, investors, friends/family and alums) of the platform and may allow them to interact through an online application. The external entity may also forecasts the liability of each loan (to schools) by using a sophisticated and proprietary credit risk model that may factor variables such as standardized test scores, relevant work experience, university ranking, and field of study among others.

The lending model of the present invention may be an innovative improvement over existing institutional loan programs provided by higher education institutions. Contrary to current alternatives, the model of the present invention may rely partially in the use of social networks (online and offline), allowing friends, family, Alumni, and external investors to invest in prospective students, and therefore reducing the credit risk and rates of each packed loan. Also there are no standard ways in which schools lend to students in today's environment; hence the alternative lending model of the present invention may guarantee that liabilities for schools are well managed by utilizing a sophisticated credit risk model and by requiring students to provide a down payment for a percentage of their tuition fees in advance. Financial aid offices may obtain personalized evaluations on their expected return for each prospective student, which will allow schools to make educated decisions on who to lend to. Finally, the school may be given the option to make portfolio based decisions to include various applicants

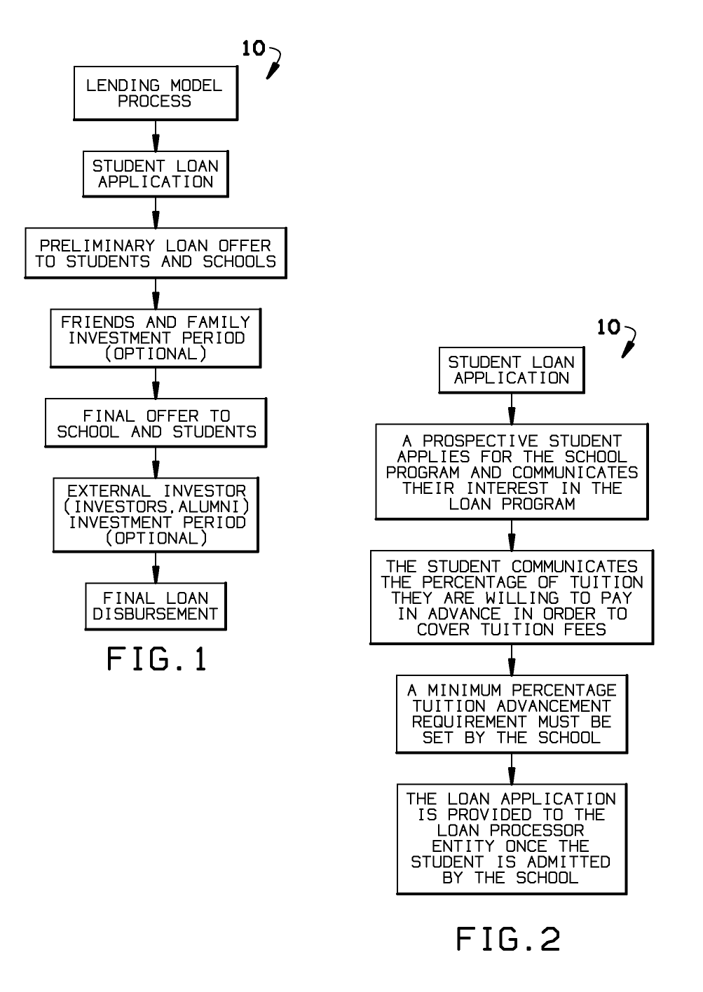

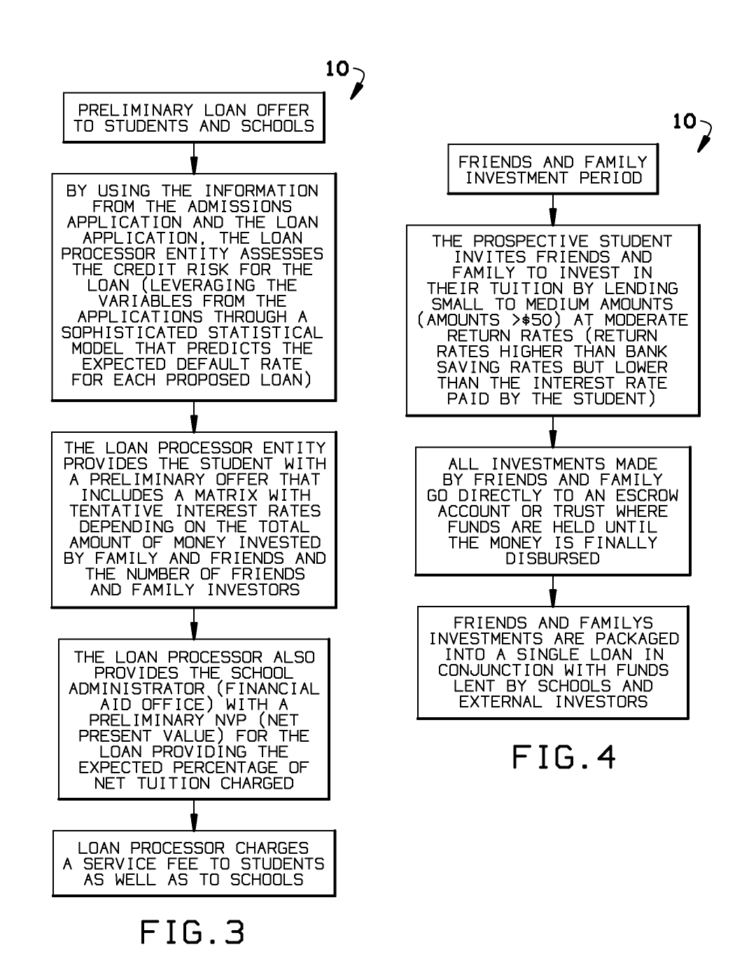

Referring to FIGS. 1 through 4, Flow Charts 10 provide details of a lending model according to an embodiment of the present invention. A student may apply for a school program and may fill out a loan application. In one embodiment of the invention, the student may communicate what upfront cash percentage he or she is willing to pay. In an alternate embodiment, the student may be told by the school what minimum upfront cash percentage is required to start the program.

By using the information from the admissions application and the loan application, the loan processor may assess the credit risk for the loan. The loan processor may provide the student with a preliminary offer that includes a matrix with tentative interest rates depending on the total amount of money invested by family and friends and the number of family and friend investors. The loan processor may also provide a school administrator, such as the financial aid office, with a preliminary net present value (NPV) valuation for the loan, providing the expected percentage of net tuition charged. The loan processor may charge a service fee to the student and/or the school for providing this service.

If the student accepts the preliminary offer from the loan processor, the student's profile may be placed on a p2p lending platform. The student may place a photo and other biographical as well as personal comments on his/her profile. The student may then send an invitation to friends and family to invest and/or donate to the student. Typically, the student may ask for small to medium amounts at moderate return rates. For example, return rates may be higher than bank savings rates but lower than the interest rate paid by the student. All investments made by friends and family may be held in an escrow account until the money is disbursed to the school. In a manner similar to the friends and family investment period, an external investor and alumni investment period may be optionally utilized by the student and school. In one embodiment, friends and family's investments may be packages into a single loan in conjunction with funds lent by the school, external investors, and alumni. This would allow the student to make one monthly payment, which may later be disbursed accordingly among the various investors, friends and family.

After the investment/donation period ends for the student, the loan processor may re-assess the risk and send new valuations to the school. The school may make a decision whether to lend to the student. If the school's decision is not to lend to the student, a portion of the service fee may be returned to the student and the friend and family investments/donations may be returned. If the school's decision is to lend to the student, a final financial package is provided to the student. If the student agrees to the terms of this final package, the student may pay the upfront cash portion before starting program coursework.

Based on the student's interest rate and the total investments from friends and family, a repayment formula may assign a return rate for external investors. Within the external investor group, alumni may participate as either investors or donors. External investors' investments may be packaged into a single loan in conjunction with funds lent by the school and by friends and family.

After the student completes the required coursework (for example, at the midpoint of the program, after each school year, or the like), the school may lend the remaining portion of tuition not covered by the student's advanced payment, friends and family investment and external investors funds. The packaged loan may be disbursed at this time and the student may start repaying the loan after the student finishes his/her education program. At this time, the loan processor may send final contracts to all users, including friends and family, investors, the school, and the student). A grace period for repayment may be offered to the student. In one embodiment, interest may begin at the time of investors' initial investment, at the time of disbursement, or at the time repayment begins. If the student does not complete the required coursework, money from friends and family and external investors may be transferred to the school and the school may refund any overage funds.

The methods of the present invention may be carried out on a computer system, including a computer network and/or a web-based computer platform. The computer may include software for determine the student's credit risk, the interest rate to be paid by the student, the interest to be paid to the investors, and the like.

It should be understood, of course, that the foregoing relates to exemplary embodiments of the invention and that modifications may be made without departing from the spirit and scope of the invention as set forth in the following claims.

What is claimed is:

1. A method for lending money to a student, the method comprising:
obtaining a school application and a financial aid application from the student, wherein the application specifies a percentage of tuition, as an upfront payment, that the student will pay before beginning a program at the school;
providing a preliminary loan offer to the student and the school;
providing a final offer to the student and the school; and
distributing a final loan disbursement to the school, wherein the final loan disbursement is made after a predetermined amount of coursework is completed by the student.

2. The method of claim 1, further comprising, after the preliminary loan offer is made to the student and the school, inviting friends and family to invest in the tuition fees of the student.

3. The method of claim 2, further comprising, after the final loan offer is made to the student and the school, inviting external investors and alumni to invest and/or donate towards the tuition fees of the student.

4. The method of claim 3, wherein the final loan disbursement includes the school or an external entity lending a portion of the tuition fees not covered by the sum of the student's upfront payment, the investment of friends and family, and the investment of external investors and alumni.

5. The method of claim 3, further comprising creating a profile of the student on a peer-to-peer lending platform, wherein the profile includes personal and biographical information about the student.

6. The method of claim 5, wherein the profile is viewable by friends and family and external investors.

7. The method of claim 3, further comprising packaging the loan as a single loan in conjunction with funds lent by the school, by friends and family, and by external investors.

8. A lending model comprising:
a single loan packaged for a student at a school, the single loan including optional investments from friends and family and external investors, wherein
the amount of the single loan is a preset amount less an upfront payment provided by the student to the school, wherein the preset amount is a percentage of total tuition fees for a predetermined program at the school.

9. The lending model of claim 8, further comprising a peer-to-peer platform onto which the student creates a profile to invite investors and donors to invest in the student's education.

10. The lending model of claim 8, further comprising a loan processor for providing a preliminary and final load offer to the student and the school.
